(19) United States
(12) Patent Application Publication
(10) Pub. No.: US 2026/0341014 A1
(43) Pub. Date: Oct. 29, 2026

(54) VIDEO COVER GENERATION METHOD, APPARATUS, MEDIUM, ELECTRONIC DEVICE, AND PROGRAM PRODUCT

(71) Applicant: BYTEDANCE TECHNOLOGY LTD., Grand Cayman (KY)

(72) Inventors: Chenfei XU, Beijing (CN); Jing Yang, Beijing (CN)

(21) Appl. No.: 19/660,206

(22) Filed: Apr. 27, 2026

(30) Foreign Application Priority Data
Apr. 28, 2025 (CN) 202510550132.X

(51) Int. Cl. G06V 10/98; G06V 10/764; G06V 20/40; G06V 20/62; G06V 30/19; G11B 27/022

(52) U.S. Cl. CPC G06V 10/993; G06V 10/764; G06V 20/46; G06V 20/62; G06V 30/19173; G11B 27/022

(57) ABSTRACT

A video cover generation method and apparatus, a medium, an electronic device, and a program product. The method includes: determining whether a video is successfully synthesized when an interface jump instruction is received; determining a plurality of video frames from a video clip of the video if the video is successfully synthesized; performing quality detection on each of the plurality of video frames; and selecting a video cover of the video from the plurality of video frames based on a quality detection result of each of the plurality of video frames.

### CROSS-REFERENCE TO RELATED APPLICATIONS

This application claims priority to Chinese Application No. 202510550132.X filed on Apr. 28, 2025, the disclosure of which is incorporated herein by reference in its entity.

### FIELD

The present disclosure relates to the field of image processing technologies, and specifically, to a video cover generation method, an apparatus, a medium, an electronic device, and a program product.

### BACKGROUND

With the rapid development of Internet technologies, short video tools or platforms attract numerous mobile Internet users, and also occupy huge traffic. Users use such short video tools or platforms to post a large number of short videos, so as to achieve the purposes of entertainment, sharing, communication, etc.

### SUMMARY

The part of the summary is provided so as to introduce the concepts in a brief form, and these concepts will be described in detail in the following part of detailed description. The part of the summary is not intended to identify key features or essential features of the claimed technical solutions, nor is intended to limit the scope of the claimed technical solutions.

In the first aspect, the present disclosure provides a video cover generation method, including:
determining whether a video is successfully synthesized in response to receiving an interface jump instruction, where the interface jump instruction is used to instruct a current interface to jump from an editing interface to a posting interface;
determining a plurality of video frames from a first video in response to the video being successfully synthesized, where the first video is a video clip of the video;
performing quality detection on each of the plurality of video frames; and
selecting a video cover of the video from the plurality of video frames based on a quality detection result of each of the plurality of video frames.

In the second aspect, the present disclosure provides a video cover generation apparatus, including:
a first determination module, configured to determine whether a video is successfully synthesized in response to receiving an interface jump instruction, where the interface jump instruction is used to instruct a current interface to jump from an editing interface to a posting interface;
a second determination module, configured to determine a plurality of video frames from a first video in response to the video being successfully synthesized, where the first video is a video clip of the video;
a quality detection module, configured to perform quality detection on each of the plurality of video frames; and
a cover selection module, configured to select a video cover of the video from the plurality of video frames based on a quality detection result of each of the plurality of video frames.

In the third aspect, the present disclosure provides a computer readable medium having a computer program stored thereon, and when the computer program is executed by a processing apparatus, the steps of the video cover generation method provided by the present disclosure in the first aspect are implemented.

In the fourth aspect, the present disclosure provides an electronic device, including:
a storage apparatus having a computer program stored thereon; and
a processing apparatus, configured to execute the computer program in the storage apparatus to implement the steps of the video cover generation method provided by the present disclosure in the first aspect.

In the fifth aspect, the present disclosure provides a computer program product including a computer program, and when the computer program is executed by a processor, the steps of the video cover generation method provided by the present disclosure in the first aspect are implemented.

Other features and advantages of the present disclosure will be described in detail in the following part of detailed description.

### BRIEF DESCRIPTION OF THE DRAWINGS

The above and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic, and the components and elements are not necessarily drawn to scale. In the drawings:

FIG. 1 is a schematic diagram of a video cover of a video in the related art.

FIG. 2 is a schematic diagram of a video according to an exemplary embodiment.

FIG. 3 is a flowchart of a video cover generation method according to an exemplary embodiment.

FIG. 4 is a schematic diagram of a video cover of a video according to an exemplary embodiment.

FIG. 5 is a flowchart of a video cover generation method according to another exemplary embodiment.

FIG. 6 is a flowchart of a video cover generation method according to yet another exemplary embodiment.

FIG. 7 is a block diagram of a video cover generation apparatus according to an exemplary embodiment.

FIG. 8 is a schematic structural diagram of an electronic device according to an exemplary embodiment.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the scope of protection of the present disclosure.

It should be understood that the various steps described in the method implementations of the present disclosure may be executed in different orders, and/or executed in parallel. In addition, the method implementations may include additional steps and/or omit the execution of the steps shown. The scope of the present disclosure is not limited in this regard.

The term "include/comprise" and its variants used herein are open-ended inclusions, that is, "include/comprise but not limited to". The term "based on" means "at least partially based on". The term "one embodiment" means "at least one embodiment"; the term "another embodiment" means "at least one other embodiment"; the term "some embodiments" means "at least some embodiments". Relevant definitions of other terms will be given in the following description.

It should be noted that the concepts such as "first" and "second" mentioned in the present disclosure are only used to distinguish different apparatuses, modules or units, and are not used to limit the sequence of functions performed by these apparatuses, modules or units, or interdependence therebetween.

It should be noted that the modifications of "one" and "a plurality of" mentioned in the present disclosure are illustrative rather than restrictive, and those skilled in the art should understand that unless otherwise clearly indicated in the context, they should be understood as "one or more".

The names of messages or information exchanged between multiple apparatuses in the implementations of the present disclosure are only used for illustrative purposes, and are not used to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner and obtain the authorization of the user in accordance with relevant laws and regulations.

For example, in response to receiving an active request from a user, prompt information is sent to the user to clearly prompt the user that the requested operation will require access to and use of the user’s personal information. In this way, the user may independently choose, based on the prompt information, whether to provide personal information to software or hardware, such as an electronic device, an application, a server, or a storage medium, that performs the operations of the technical solutions of the present disclosure.

As an optional but non-limiting implementation, in response to receiving the user’s active request, the prompt information may be sent to the user in the form of, for example, a pop-up window, in which the prompt information may be presented in text. In addition, the pop-up window may also include a selection control for the user to choose whether to "agree" or "disagree" to provide personal information to the electronic device.

It may be understood that the above process of notifying and obtaining user authorization is only illustrative, and does not constitute a limitation on the implementations of the present disclosure. Other methods that meet relevant laws and regulations may also be applied to the implementations of the present disclosure.

At the same time, it may be understood that the data involved in the technical solution (including but not limited to the data itself, acquisition or use of the data) should comply with the requirements of corresponding laws, regulations and related provisions.

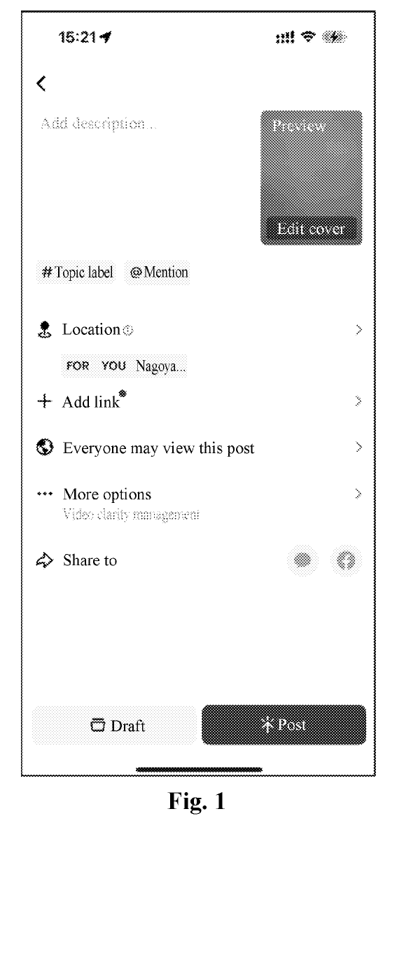

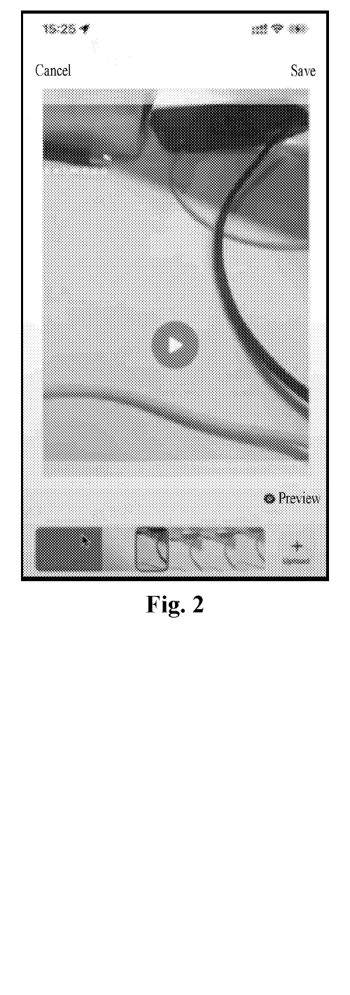

When entering the video posting interface, the first frame of the video is used as the cover by default. As shown in FIG. 1, the first frame of the video to be posted in FIG. 2 is used as the default cover, which may be completely black or blurred. In this case, the user needs to edit the cover additionally, which is time-consuming and labor-intensive.

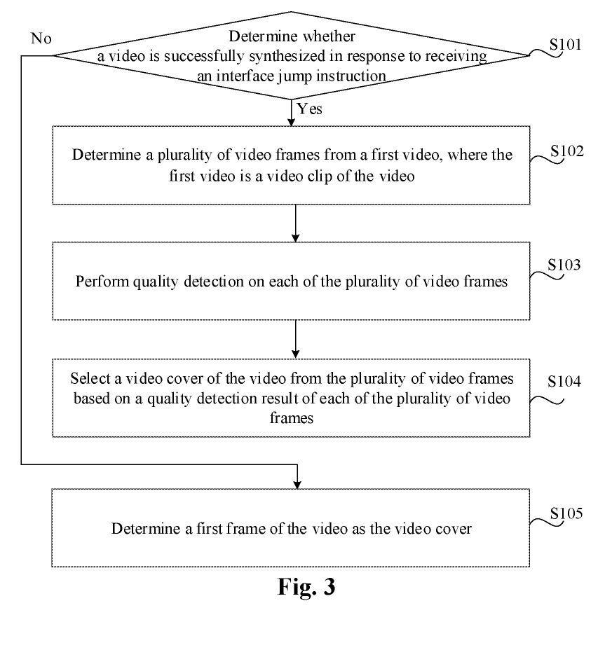

FIG. 3 is a flowchart of a video cover generation method according to an exemplary embodiment. As shown in FIG. 3, the video cover generation method may include the following S101 to S105.

In S101, whether a video is successfully synthesized is determined in response to receiving an interface jump instruction.

In the present disclosure, the interface jump instruction is used to instruct a current interface to jump from an editing interface to a posting interface. Exemplarily, a user may trigger the interface jump instruction by clicking a "next" operation button.

When editing a video, the user may add information such as effects, audio, subtitles, etc. to the video, and then the video synthesis will be performed. In order to avoid the problem that the subsequently selected video cover is not a frame in the finally posted video, it may be ensured that the video is successfully synthesized before the video frame is extracted. Therefore, when the interface jump instruction used to instruct the current interface to jump from the editing interface to the posting interface is received, it may first be determined whether the video is successfully synthesized. If the video is successfully synthesized, the following S102 to S104 are executed; if the video is not successfully synthesized, the following S105 is executed.

In S102, a plurality of video frames are determined from a first video, where the first video is a video clip of the video.

In the present disclosure, the video refers to video data that any user may pre-generate through various video applications and needs to be posted to the Internet for wide dissemination, so as to implement network social interaction, for example, a short video recorded by a user. After the user finishes editing the recorded video, the interface jump instruction may be triggered, and then it is determined whether the video is successfully synthesized; if the video is successfully synthesized, S102 to S104 may be executed to automatically select a video cover from the video as the default cover of the video in the posting interface.

Among them, the first video may be a video clip in any period of time of the video. Preferably, the first video is a video clip in a first preset duration of the video.

If the total duration of the video is greater than a preset duration (for example, 3 seconds), the video clip in the first preset duration of the video is used as a first video clip; if the total duration of the video is less than or equal to the preset duration, the video is directly used as the first video clip.

When shooting a video, the user usually puts the most important information or plot at the beginning of the video, and selecting a cover from the images in the first half of the video may enable the video cover to better reflect the core content of the video, so that the user may have a preliminary understanding of the theme and style of the video. In addition, effects are usually added to the first half of the video, and selecting a cover from the first half of the video may better show the highlights and creativity of the video, and improve the attractiveness of the video.

In addition, the plurality of video frames may be determined from the first video according to a preset method, where the preset method may be random extraction, extraction according to a plurality of preset timestamps, or uniform extraction (for example, at a certain interval of duration or at a certain interval of frames), which is not limited by the present disclosure.

In S103, quality detection is performed on each of the plurality of video frames.

In the present disclosure, for each of the plurality of video frames, a quality score may be given to the video frame by a quality detection model as the quality detection result of the video frame. The quality detection model may give a quality score to the video frame from multiple dimensions such as a face, a portrait, clarity, contrast, and color balance.

In S104, a video cover of the video is selected from the plurality of video frames based on the quality detection result of each of the plurality of video frames.

In the present disclosure, after obtaining the quality scores of the plurality of extracted video frames, the video frame with the highest quality score in the plurality of video frames may be determined as the video cover of the video and displayed as the default cover of the video in the posting interface.

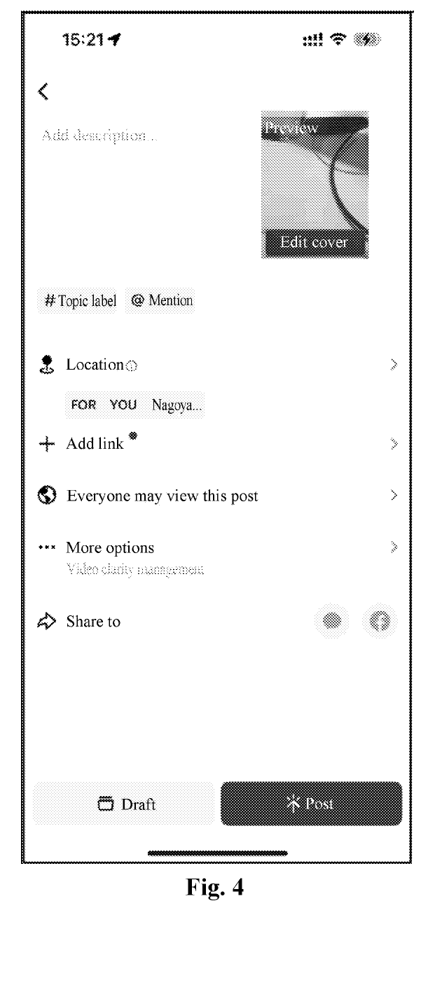

Exemplarily, as shown in FIG. 4, the middle frame of the video in FIG. 2 is displayed as the default cover in the posting interface.

In S105, a first frame of the video is determined as the video cover.

When the video is not successfully synthesized, no more waiting for the video synthesis, instead, the first frame of the video is directly used as the video cover of the video, so as to ensure the timely display of the video cover in the posting interface.

In the above technical solutions, when the interface jump instruction used to instruct the current interface to jump from the editing interface to the posting interface is received, it is first determined whether the video is successfully synthesized; if the video is successfully synthesized, a plurality of video frames are extracted from the video clip of the video; then, quality detection is performed on each of the plurality of extracted video frames; finally, the video cover of the video is selected from the plurality of video frames based on the quality detection result of each of the plurality of video frames. In this way, a video cover with better quality may be automatically selected from the video, so as to avoid the situation of being completely black or blurred, thereby saving the user the cumbersome steps of additionally editing the cover, and providing a more convenient video posting experience. In addition, before the video frame is extracted, it is ensured that the video is successfully synthesized, which may avoid the problem that the subsequently selected video cover is not a frame in the finally posted video. In addition, through the frame extraction operation, the selection range of the video cover may be reduced, thereby improving the generation efficiency of the video cover.

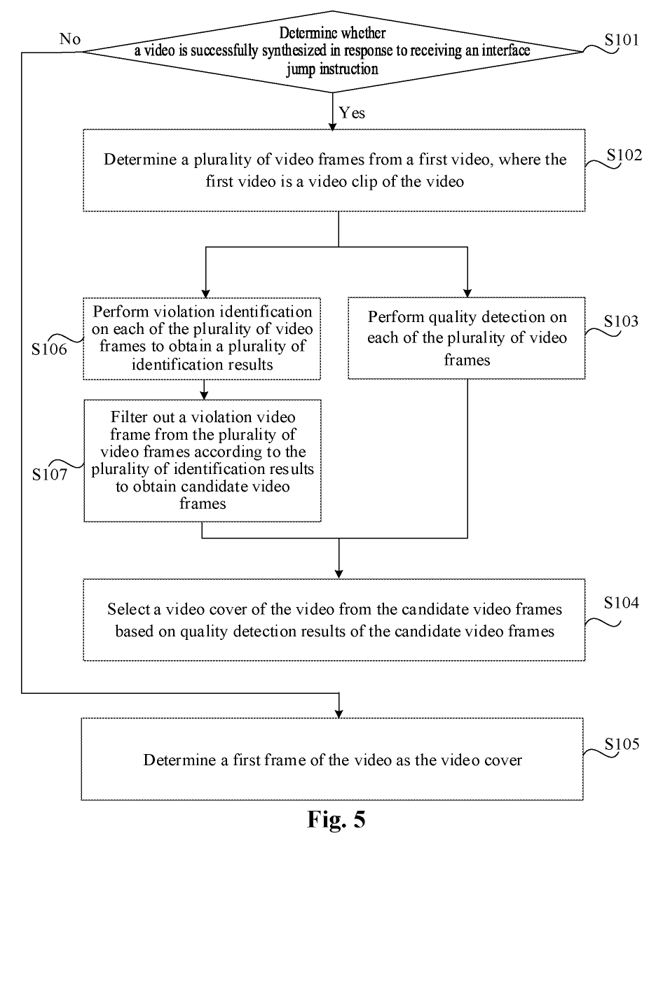

FIG. 5 is a flowchart of a video cover generation method according to another exemplary embodiment. As shown in FIG. 5, before S104, the video cover generation method may further include the following S106 and S107.

In S106, non-compliant identification is performed on each of the plurality of video frames to obtain a plurality of identification results.

In the present disclosure, a classification model may be used to identify the non-compliant of the video frame to distinguish normal and non-compliant behaviors, where the non-compliant behaviors may include privacy, pornography, etc. The classification module determines whether the video frame contains pornographic non-compliant information by identifying an exposed area of a person’s skin and a key part in the video frame.

In S107, a non-compliant video frame is filtered out from the plurality of video frames according to the plurality of identification results to obtain candidate video frames.

At this time, S104 may include: selecting the video cover of the video from the candidate video frames based on a quality detection results of the candidate video frames.

In the above implementation, the video frame involving the non-compliant behavior is first filtered out from the plurality of extracted video frames, and then the video cover of the video is selected from the remaining video frames, which may ensure that the video cover does not contain any non-compliant content, and prevent the user from contacting bad images when browsing the cover.

The specific implementation of performing non-compliant identification on each of the plurality of video frames in S106 will be described in detail below. Specifically, S106 may include the following steps (a1) to (a3).

Step (a1): For each of the plurality of video frames, an image feature of the video frame is extracted.

Step (a2): The image feature of the video frame is inputted into a pre-trained image classification model to obtain a classification result.

Among them, the classification result is used to characterize whether the video frame is violated.

Step (a3): Whether the video frame is violated is determined according to the classification result.

In order to improve the comprehensiveness and accuracy of non-compliant detection, in addition to the non-compliant detection at the visual image level of the video frame, the non-compliant detection may also be performed on the text content in the video frame. Specifically, before step (a3), S106 may further include the following steps (a4) and (a5).

Step (a4): For each of the plurality of video frames, text information in the video frame is extracted.

In the present disclosure, the text information may be extracted from the video frame through a text recognition technology, such as an optical character recognition technology.

Step (a5): Whether the text information in the video frame contains a preset sensitive word is identified to obtain a text identification result.

Specifically, if the preset sensitive word exists in the text information in the video frame, it indicates that the video frame is violated; if the preset sensitive word does not exist in the text information in the video frame, it indicates that the video frame is normal. The text identification result is used to characterize whether the video frame is violated.

At this time, step (a3) may include: determining whether the video frame is violated according to the classification result and the text identification result of the video frame.

Specifically, if the classification result of the video frame characterizes that the video frame is violated, or the text identification result of the video frame characterizes that the video frame is violated, it is determined that the video frame is violated; if the classification result of the video frame characterizes that the video frame is normal, and the text identification result of the video frame characterizes that the video frame is normal, it is determined that the video frame is normal.

In a possible implementation, the video cover generation method may further include the following steps (b1) to (b6).

Step (b1): Whether a video cover generation code is cached locally is determined in response to detecting that a current interface jumps to the editing interface.

In the present disclosure, the video cover generation code is used to implement the steps of the video cover generation method in the present disclosure to automatically generate the video cover. If the user uses the video application for the first time after the download of the video application is complete, the video cover generation code may first be downloaded from the cloud and cached locally. Therefore, when the current interface jumps to the editing interface, it may first be determined whether the video cover generation code is cached locally. If the video cover generation code is cached locally, it indicates that the cached video cover generation code may be used to automatically select the video cover. At this time, step (b2) may be executed; if the video cover generation code is not cached locally, steps (b3) and (b4) may be executed.

Step (b2): The cached video cover generation code is executed to implement the above S102 to S104 when the video is successfully synthesized.

Step (b3): The video cover generation code is downloaded and cached.

Step (b4): Whether the video cover generation code is completely cached is determined when the interface jump instruction is received.

If the video cover generation code is completely cached and the video is successfully synthesized, step (b5) is executed; if the video cover generation code is not completely cached and the video is successfully synthesized, step (b6) is executed.

Step (b5): The cached video cover generation code is executed to implement the above S102 to S104.

Step (b6): The first frame of the video is determined as the video cover.

When it is detected that the current interface jumps to the editing interface, it is determined whether the video cover generation code is cached locally. In this way, when the video cover generation code is not cached locally, it may be downloaded and cached in time to ensure that the video cover generation code may be used to generate the video cover for this video posting as much as possible. In addition, when the video cover generation code is not completely cached, no more waiting for the caching to be completed, instead, the first frame of the video is directly used as the video cover of the video, so as to ensure the timely display of the video cover in the posting interface.

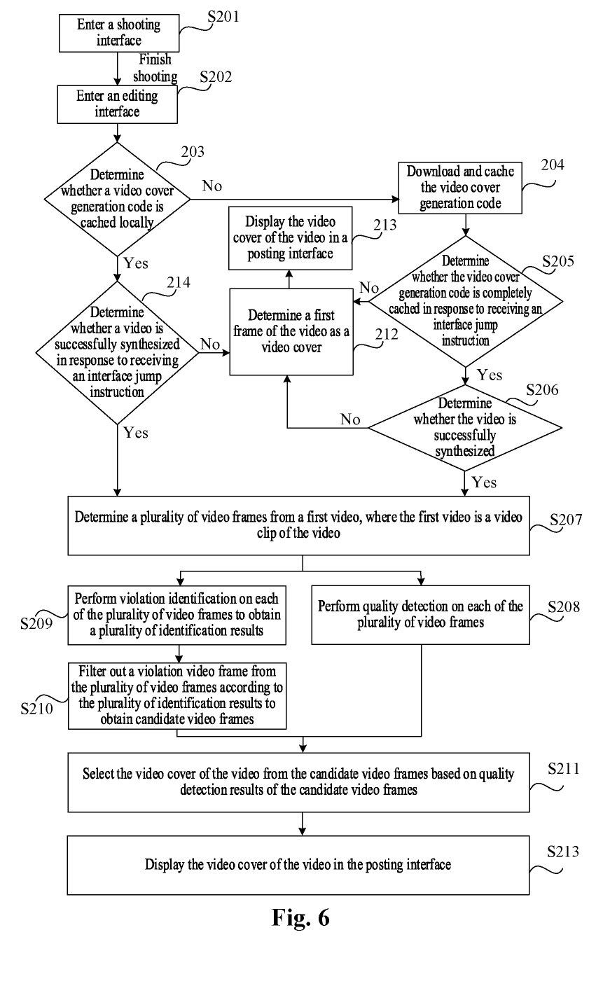

FIG. 6 is a flowchart of a video cover generation method according to yet another exemplary embodiment. As shown in FIG. 6, the video cover generation method may include the following S201 to S214.

In S201, a shooting interface is entered.

In S202, an editing interface is entered.

When the user clicks the shooting button on the homepage of the video application, the shooting interface is entered, and when the shooting is finished, the editing interface is automatically entered.

In S203, whether a video cover generation code is cached locally is determined.

In the present disclosure, after entering the editing interface, it may be determined whether the video cover generation code is cached locally. If the video cover generation code is not cached locally, the following S204 and S205 are executed. If the video cover generation code is cached locally, the following S214 is executed.

In S204, the video cover generation code is downloaded and cached.

In S205, whether the video cover generation code is completely cached is determined in response to receiving an interface jump instruction.

If the video cover generation code is completely cached, the following S206 is executed; if the video cover generation code is not completely cached, the following S212 and S213 are executed.

In S206, whether a video is successfully synthesized is determined.

If the video is successfully synthesized, the following S207 to S211 are executed, and then S213 is executed. If the video is not successfully synthesized, the following S212 and S213 are executed.

In S207, a plurality of video frames are determined from a first video, where the first video is a video clip of the video.

In S208, quality detection is performed on each of the plurality of video frames.

In S209, non-compliant identification is performed on each of the plurality of video frames to obtain a plurality of identification results.

In S210, a non-compliant video frame is filtered out from the plurality of video frames according to the plurality of identification results to obtain candidate video frames.

In S211, a video cover of the video is selected from the candidate video frames based on quality detection results of the candidate video frames.

In S212, a first frame of the video is determined as the video cover.

In S213, the video cover of the video is displayed in the posting interface.

In S214, whether the video is successfully synthesized is determined in response to receiving the interface jump instruction.

If the video is successfully synthesized, the above S207 to S211 are executed, and then the above S213 is executed; if the video is not successfully synthesized, the above S212 and S213 are executed.

FIG. 7 is a block diagram of a video cover generation apparatus according to an exemplary embodiment. As shown in FIG. 7, the video cover generation apparatus 300 includes:
a first determination module 301, configured to determine whether a video is successfully synthesized in response to receiving an interface jump instruction, where the interface jump instruction is used to instruct a current interface to jump from an editing interface to a posting interface;
a second determination module 302, configured to determine a plurality of video frames from a first video in response to the video being successfully synthesized, where the first video is a video clip of the video;
a quality detection module 303, configured to perform quality detection on each of the plurality of video frames; and
a cover selection module 304, configured to select a video cover of the video from the plurality of video frames based on a quality detection result of each of the plurality of video frames.

In the above technical solutions, when the interface jump instruction used to instruct the current interface to jump from the editing interface to the posting interface is received, it is first determined whether the video is successfully synthesized; if the video is successfully synthesized, a plurality of video frames are extracted from the video clip of the video; then, quality detection is performed on each of the plurality of extracted video frames; finally, the video cover of the video is selected from the plurality of video frames based on the quality detection result of each of the plurality of video frames. In this way, a video cover with better quality may be automatically selected from the video, so as to avoid the situation of being completely black or blurred, thereby saving the user the cumbersome steps of additionally editing the cover, and providing a more convenient video posting experience. In addition, before the video frame is extracted, it is ensured that the video is successfully synthesized, which may avoid the problem that the subsequently selected video cover is not a frame in the finally posted video. In addition, through the frame extraction operation, the selection range of the video cover may be reduced, thereby improving the generation efficiency of the video cover.

Optionally, the video cover generation apparatus 300 further includes:
a non-compliant identification module, configured to perform non-compliant identification on each of the plurality of video frames to obtain a plurality of identification results before the cover selection module 304 selects the video cover of the video from the plurality of video frames based on the quality detection result of each of the plurality of video frames;
a filtering module, configured to filter out a non-compliant video frame from the plurality of video frames according to the plurality of identification results to obtain candidate video frames; and
the cover selection module 304 is configured to select the video cover of the video from the candidate video frame based on quality detection results of the candidate video frames.

Optionally, the non-compliant identification module includes:
a first extraction sub-module, configured to extract, for each of the plurality of video frames, an image feature of the video frame;
a classification sub-module, configured to input the image feature into a pre-trained image classification model to obtain a classification result; and
a determination sub-module, configured to determine whether the video frame is violated according to the classification result.

Optionally, the non-compliant identification module further includes:
a second extraction sub-module, configured to extract, for each of the plurality of video frames, text information in the video frame before the determination sub-module determines whether the video frame is violated according to the classification result; and
an identification sub-module, configured to identify whether the text information contains a preset sensitive word to obtain a text identification result; and
the determination sub-module is configured to determine whether the video frame is violated according to the classification result and the text identification result.

Optionally, the video cover generation apparatus 300 further includes:
a third determination module, configured to determine a first frame of the video as the video cover in response to the video being not successfully synthesized.

Optionally, the video cover generation apparatus 300 further includes:
a fourth determination module, configured to determine whether a video cover generation code is cached locally in response to detecting that the current interface jumps to the editing interface; and
a first execution module, configured to execute the cached video cover generation code in response to the video being successfully synthesized in response to the video cover generation code being cached locally, to implement functions of the second determination module 302, the quality detection module 303, and the cover selection module 304.

Optionally, the video cover generation apparatus 300 further includes:
a caching module, configured to download and cache the video cover generation code in response to the video cover generation code being not cached locally;
a fifth determination module, configured to determine whether the video cover generation code is completely cached in response to the interface jump instruction being received; and
a second execution module, configured to execute the cached video cover generation code to implement the functions of the second determination module 302, the quality detection module 303, and the cover selection module 304 in response to the video cover generation code being completely cached and the video being successfully synthesized.

Optionally, the video cover generation apparatus 300 further includes:
a sixth determination module, configured to determine the first frame of the video as the video cover in response to the video cover generation code being not completely cached.

The present disclosure further provides a computer readable medium having a computer program stored thereon, and when the computer program is executed by a processing apparatus, the steps of the video cover generation method provided by the present disclosure are implemented.

The present disclosure further provides an electronic device, including:
a storage apparatus having a computer program stored thereon; and
a processing apparatus, configured to execute the computer program in the storage apparatus to implement the steps of the video cover generation method provided by the present disclosure.

The present disclosure further provides a computer program product including a computer program, and when the computer program is executed by a processor, the steps of the video cover generation method provided by the present disclosure are implemented.

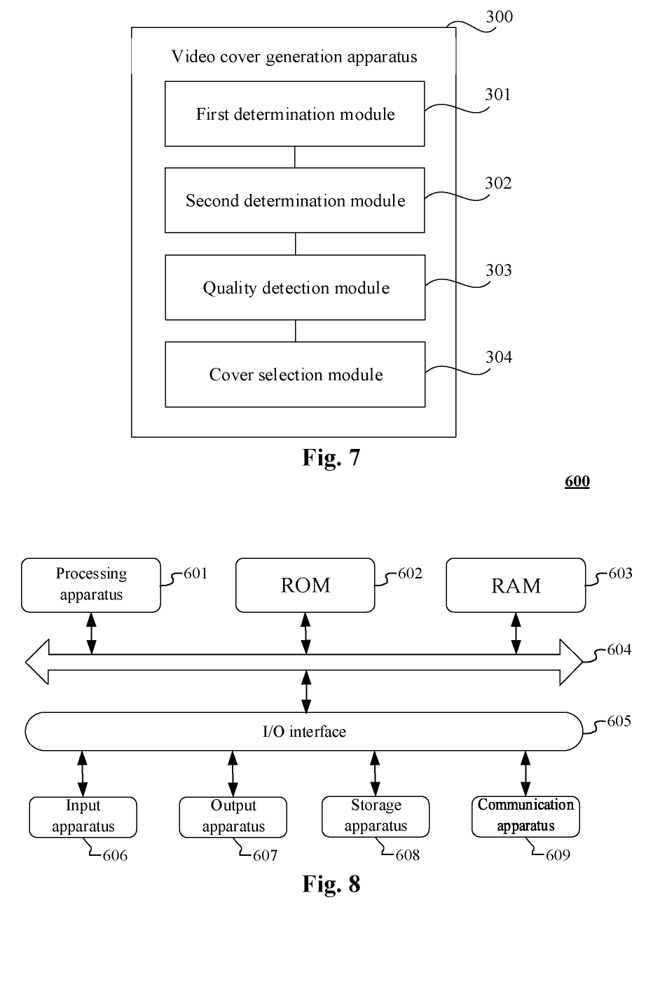

Reference is made to FIG. 8 below, which illustrates a schematic structural diagram of an electronic device (such as a terminal device or a server) 600 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a tablet computer, a PMP (portable multimedia player), an in-vehicle terminal (e.g., an in-vehicle navigation terminal), and the like, and fixed terminals such as a digital TV, a desktop computer, and the like. The electronic device shown in FIG. 8 is only an example, and should not impose any limitation on the function and scope of use of the embodiments of the present disclosure.

As shown in FIG. 8, the electronic device 600 may include a processing apparatus (such as a central processing unit, a graphics processor and the like) 601, which may perform various appropriate actions and processes according to a program stored in a read-only memory (ROM) 602 or a program loaded from a storage apparatus 608 into a random access memory (RAM) 603. In the RAM 603, various programs and data necessary for the operation of the electronic device 600 are also stored. The processing apparatus 601, the ROM 602 and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope and the like; an output apparatus 607 including, for example, a liquid crystal display (LCD), a speaker, a vibrator and the like; the storage apparatus 608 including, for example, a magnetic tape, a hard disk and the like; and a communication apparatus 609. The communication apparatus 609 may allow the electronic device 600 to perform wireless or wired communication with other devices to exchange data. Although FIG. 8 shows the electronic device 600 with various apparatuses, it should be understood that it is not required to implement or have all of the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program contains program codes for executing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiments of the present disclosure are executed.

It should be noted that the computer-readable medium in the present disclosure may be a computer-readable signal medium, a computer-readable storage medium, or any combination of the above two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus or device. In the present disclosure, the computer-readable signal medium may include a data signal propagated in a baseband or as a part of a carrier wave, and computer-readable program codes are carried therein. Such a propagated data signal may adopt various forms, including but not limited to, an electromagnetic signal, an optical signal, or any suitable combination of the above. The computer-readable signal medium may also be any computer-readable medium other than the computer-readable storage medium, and the computer-readable signal medium may send, propagate or transmit a program used by or in combination with an instruction execution system, apparatus or device. The program codes contained on the computer-readable medium may be transmitted by any suitable medium, including but not limited to: a wire, an optical cable, a radio frequency (RF), or any suitable combination of the above.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above computer-readable medium may be included in the above electronic device, or may exist alone without being assembled into the electronic device.

The above computer-readable medium carries one or more programs, and the one or more programs, when executed by the electronic device, cause the electronic device to: determine whether a video is successfully synthesized in response to receiving an interface jump instruction, where the interface jump instruction is used to instruct a current interface to jump from an editing interface to a posting interface; determine a plurality of video frames from a first video if the video is successfully synthesized, where the first video is a video clip of the video; performs quality detection on each of the plurality of video frames; and select a video cover of the video from the plurality of video frames based on a quality detection result of each of the plurality of video frames.

The computer program code for performing the operations of the present disclosure may be written in one or more programming languages or a combination thereof, the programming languages including but not limited to object-oriented programming languages such as Java, Smalltalk, C++, and conventional procedural programming languages such as "C" language or similar programming languages. The program codes may be executed entirely on a user's computer, partly on the user's computer, as a stand-alone software package, partly on the user's computer and partly on a remote computer, or entirely on the remote computer or a server. In the scenario involving the remote computer, the remote computer may be connected to the user's computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, a program segment, or a part of code that includes one or more executable instructions for implementing specified logical functions. It should also be noted that, in some alternative implementations, functions indicated in the blocks may occur in an order different from that indicated in the drawings. For example, two blocks shown in succession may, in fact, be executed substantially concurrently, or the blocks may sometimes be executed in a reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The modules involved in the embodiments described in the present disclosure may be implemented by means of software, and may also be implemented by means of hardware. The name of a module does not constitute a limitation on the module itself under certain circumstances, for example, the first determination module may be described as "a module for determining a plurality of video frames from a first video".

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and the like.

In the context of the present disclosure, a machine-readable medium may be a tangible medium that may contain or store programs for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium would include an electrical connection on the basis of one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a video cover generation method, including:
determining whether a video is successfully synthesized in response to receiving an interface jump instruction, where the interface jump instruction is used to instruct a current interface to jump from an editing interface to a posting interface;
determining a plurality of video frames from a first video in response to the video being successfully synthesized, where the first video is a video clip of the video;
performing quality detection on each of the plurality of video frames; and
selecting a video cover of the video from the plurality of video frames based on a quality detection result of each of the plurality of video frames.

According to one or more embodiments of the present disclosure, Example 2 provides the method of Example 1, and before the step of selecting the video cover of the video from the plurality of video frames based on the quality detection result of each of the plurality of video frames, the method further includes:
performing non-compliant identification on each of the plurality of video frames to obtain a plurality of identification results; and
filtering out a non-compliant video frame from the plurality of video frames according to the plurality of identification results to obtain a candidate video frame; and
selecting the video cover of the video from the plurality of video frames based on the quality detection result of each of the plurality of video frames includes:
selecting the video cover of the video from the candidate video frame based on a quality detection result of the candidate video frame.

According to one or more embodiments of the present disclosure, Example 3 provides the method of Example 2, and performing non-compliant identification on each of the plurality of video frames includes:
extracting, for each of the plurality of video frames, an image feature of the video frame;
inputting the image feature into a pre-trained image classification model to obtain a classification result; and
determining whether the video frame is violated according to the classification result.

According to one or more embodiments of the present disclosure, Example 4 provides the method of Example 3, and before the step of determining whether the video frame is violated according to the classification result, performing non-compliant identification on each of the plurality of video frames further includes:
extracting, for each of the plurality of video frames, text information in the video frame; and
identifying whether the text information contains a preset sensitive word to obtain a text identification result; and
determining whether the video frame is violated according to the classification result includes:
determining whether the video frame is violated according to the classification result and the text identification result.

According to one or more embodiments of the present disclosure, Example 5 provides the method of Example 1, and the method further includes:
determining a first frame of the video as the video cover in response to the video being not successfully synthesized.

According to one or more embodiments of the present disclosure, Example 6 provides the method of Example 1, and the method further includes:
determining whether a video cover generation code is cached locally in response to detecting that the current interface jumps to the editing interface; and
executing the cached video cover generation code in response to the video being successfully synthesized in response to the video cover generation code being cached locally, to implement the step of determining the plurality of video frames from the first video to the step of selecting the video cover of the video from the plurality of video frames based on the quality detection result of each of the plurality of video frames.

According to one or more embodiments of the present disclosure, Example 7 provides the method of Example 6, and the method further includes:
downloading and caching the video cover generation code in response to the video cover generation code being not cached locally;
determining whether the video cover generation code is completely cached when the interface jump instruction is received; and
executing the cached video cover generation code to implement the step of determining the plurality of video frames from the first video to the step of selecting the video cover of the video from the plurality of video frames based on the quality detection result of each of the plurality of video frames in response to the video cover generation code being completely cached and the video being successfully synthesized.

According to one or more embodiments of the present disclosure, Example 8 provides the method of Example 7, and the method further includes:
determining a first frame of the video as the video cover in response to the video cover generation code being not completely cached.

According to one or more embodiments of the present disclosure, Example 9 provides a video cover generation apparatus, including:
a first determination module, configured to determine whether a video is successfully synthesized in response to receiving an interface jump instruction, where the interface jump instruction is used to instruct a current interface to jump from an editing interface to a posting interface;
a second determination module, configured to determine a plurality of video frames from a first video in response to the video being successfully synthesized, where the first video is a video clip of the video;
a quality detection module, configured to perform quality detection on each of the plurality of video frames; and
a cover selection module, configured to select a video cover of the video from the plurality of video frames based on a quality detection result of each of the plurality of video frames.

According to one or more embodiments of the present disclosure, Example 10 provides a computer-readable medium having a computer program stored thereon, and when the computer program is executed by a processing apparatus, the steps of the method according to any one of Examples 1 to 8 are implemented.

According to one or more embodiments of the present disclosure, Example 11 provides an electronic device, including:
a storage apparatus having a computer program stored thereon; and
a processing apparatus, configured to execute the computer program in the storage apparatus to implement the steps of the method according to any one of Examples 1 to 8.

According to one or more embodiments of the present disclosure, Example 12 provides a computer program product including a computer program, and when the computer program is executed by a processor, the steps of the method according to any one of Examples 1 to 8 are implemented.

The above description is merely illustration of preferred embodiments of the present disclosure and applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above concept of disclosure. For example, the above features and the technical features provided in the present disclosure (but not limited to) with similar functions may be replaced each other to form a technical solution.

In addition, although the various operations are depicted in a specific order, this should not be understood as requiring the operations to be performed in the specific order shown or in sequential order. Under certain circumstances, multitasking and parallel processing may be beneficial. Similarly, although the above discussion contains a number of specific implementation details, these should not be construed as limiting the scope of the present disclosure. Certain features described in the context of separate embodiments may also be implemented in a single embodiment in combination. On the contrary, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms for implementing the claims. Regarding the apparatuses in the above embodiments, the specific manner in which each module performs an operation has been described in detail in the embodiments relating to the method, and will not be described in detail herein.

We claim:

1. A video cover generation method, comprising:
determining whether a video is successfully synthesized in response to receiving an interface jump instruction, wherein the interface jump instruction is used to instruct a current interface to jump from an editing interface to a posting interface;
determining a plurality of video frames from a first video in response to the video being successfully synthesized, wherein the first video is a video clip of the video;
performing quality detection on each video frame of the plurality of video frames; and
selecting a video cover of the video from the plurality of video frames based on a quality detection result of each video frame of the plurality of video frames.

2. The method of claim 1, wherein before a step of selecting the video cover of the video from the plurality of video frames based on the quality detection result of each video frame of the plurality of video frames, the method further comprises:
obtaining a plurality of identification results by performing non-compliant identification on each video frame of the plurality of video frames; and
obtaining candidate video frames by filtering out a non-compliant video frame from the plurality of video frames according to the plurality of identification results; and
selecting the video cover of the video from the plurality of video frames based on the quality detection result of each video frame of the plurality of video frames comprises:
selecting the video cover of the video from the candidate video frames based on quality detection results of the candidate video frames.

3. The method of claim 2, wherein performing the non-compliant identification on each video frame of the plurality of video frames comprises:
extracting, for each video frame of the plurality of video frames, an image feature of the video frame;
obtaining a classification result by inputting the image feature into a pre-trained image classification model; and
determining whether the video frame is violated according to the classification result.

4. The method of claim 3, wherein before a step of determining whether the video frame is violated according to the classification result, performing the non-compliant identification on each video frame of the plurality of video frames further comprises:
extracting, for each video frame of the plurality of video frames, text information in the video frame; and
obtaining a text identification result by identifying whether the text information contains a predefined sensitive word; and
determining whether the video frame is violated according to the classification result comprises:
determining whether the video frame is violated according to the classification result and the text identification result.

5. The method of claim 1, further comprising:
determining a first frame of the video as the video cover in response to the video being not successfully synthesized.

6. The method of claim 1, further comprising:
determining whether a video cover generation code is cached locally in response to detecting that the current interface jumps to the editing interface; and
executing the cached video cover generation code in response to the video being successfully synthesized in response to the video cover generation code being cached locally, to implement a step of determining the plurality of video frames from the first video to a step of selecting the video cover of the video from the plurality of video frames based on the quality detection result of each video frame of the plurality of video frames.

7. The method of claim 6, further comprising:
downloading and caching the video cover generation code in response to the video cover generation code being not cached locally;
determining whether the video cover generation code is fully cached in response to the interface jump instruction being received; and
executing the cached video cover generation code to implement the step of determining the plurality of video frames from the first video to the step of selecting the video cover of the video from the plurality of video frames based on the quality detection result of each video frame of the plurality of video frames in response to the video cover generation code being fully cached and the video being successfully synthesized.

8. The method of claim 7, further comprising:
determining a first frame of the video as the video cover in response to the video cover generation code being not cached fully.

9. A non-transitory computer-readable storage medium having a computer program stored thereon, wherein the computer program, when executed by a processor, causes the processor to:
determine whether a video is successfully synthesized in response to receiving an interface jump instruction, wherein the interface jump instruction is used to instruct a current interface to jump from an editing interface to a posting interface;
determine a plurality of video frames from a first video in response to the video being successfully synthesized, wherein the first video is a video clip of the video;
perform quality detection on each video frame of the plurality of video frames; and
select a video cover of the video from the plurality of video frames based on a quality detection result of each video frame of the plurality of video frames.

10. The storage medium of claim 9, wherein before a step of selecting the video cover of the video from the plurality of video frames based on the quality detection result of each video frame of the plurality of video frames, the computer program further comprises instructions to:
obtain a plurality of identification results by performing non-compliant identification on each video frame of the plurality of video frames; and
obtain candidate video frames by filtering out a non-compliant video frame from the plurality of video frames according to the plurality of identification results; and
wherein the computer program causing the processor to select the video cover of the video from the plurality of video frames based on the quality detection result of each video frame of the plurality of video frames comprises instructions to:
select the video cover of the video from the candidate video frames based on quality detection results of the candidate video frames.

11. The storage medium of claim 10, wherein the computer program causing the processor to perform the non-compliant identification on each video frame of the plurality of video frames comprises instructions to:
extract, for each video frame of the plurality of video frames, an image feature of the video frame;
obtain a classification result by inputting the image feature into a pre-trained image classification model; and
determine whether the video frame is violated according to the classification result.

12. The storage medium of claim 11, wherein before a step of determining whether the video frame is violated according to the classification result, the computer program causing the processor to perform the non-compliant identification on each video frame of the plurality of video frames further comprises:
extract, for each video frame of the plurality of video frames, text information in the video frame; and
obtain a text identification result by identifying whether the text information contains a predefined sensitive word; and
determine whether the video frame is violated according to the classification result comprises:
determine whether the video frame is violated according to the classification result and the text identification result.

13. An electronic device, comprising:
a storage having a computer program stored thereon; and
a processor, configured to execute the computer program in the storage to:
determine whether a video is successfully synthesized in response to receiving an interface jump instruction, wherein the interface jump instruction is used to instruct a current interface to jump from an editing interface to a posting interface;
determine a plurality of video frames from a first video in response to the video being successfully synthesized, wherein the first video is a video clip of the video;
perform quality detection on each video frame of the plurality of video frames; and
select a video cover of the video from the plurality of video frames based on a quality detection result of each video frame of the plurality of video frames.

14. The electronic device of claim 13, wherein before a step of selecting the video cover of the video from the plurality of video frames based on the quality detection result of each video frame of the plurality of video frames, the computer program further comprises instructions to:
obtain a plurality of identification results by performing non-compliant identification on each video frame of the plurality of video frames; and
obtain candidate video frames by filtering out a non-compliant video frame from the plurality of video frames according to the plurality of identification results; and
wherein the computer program causing the processor to select the video cover of the video from the plurality of video frames based on the quality detection result of each video frame of the plurality of video frames comprises instructions to:
select the video cover of the video from the candidate video frames based on quality detection results of the candidate video frames.

15. The electronic device of claim 14, wherein the computer program causing the processor to perform the non-compliant identification on each video frame of the plurality of video frames comprises instructions to:
extract, for each video frame of the plurality of video frames, an image feature of the video frame;
obtain a classification result by inputting the image feature into a pre-trained image classification model; and
determine whether the video frame is violated according to the classification result.

16. The electronic device of claim 15, wherein before a step of determining whether the video frame is violated according to the classification result, the computer program causing the processor to perform the non-compliant identification on each video frame of the plurality of video frames further comprises:
extract, for each video frame of the plurality of video frames, text information in the video frame; and
obtain a text identification result by identifying whether the text information contains a predefined sensitive word; and
determine whether the video frame is violated according to the classification result comprises:
determine whether the video frame is violated according to the classification result and the text identification result.

17. The electronic device of claim 13, wherein the computer program further comprises instructions to:
determine a first frame of the video as the video cover in response to the video being not successfully synthesized.

18. The electronic device of claim 13, wherein the computer program further comprises instructions to:
determine whether a video cover generation code is cached locally in response to detecting that the current interface jumps to the editing interface; and
execute the cached video cover generation code in response to the video being successfully synthesized in response to the video cover generation code being cached locally, to implement a step of determining the plurality of video frames from the first video to a step of selecting the video cover of the video from the plurality of video frames based on the quality detection result of each video frame of the plurality of video frames.

19. The electronic device of claim 18, wherein the computer program further comprises instructions to:
download and cache the video cover generation code in response to the video cover generation code being not cached locally;
determine whether the video cover generation code is fully cached in response to the interface jump instruction being received; and
execute the cached video cover generation code to implement the step of determining the plurality of video frames from the first video to the step of selecting the video cover of the video from the plurality of video frames based on the quality detection result of each video frame of the plurality of video frames in response to the video cover generation code being fully cached and the video being successfully synthesized.

20. The electronic device of claim 19, wherein the computer program further comprises instructions to:
determine a first frame of the video as the video cover in response to the video cover generation code being not cached fully.
